(19) United States
(12) Patent Application Publication
(10) Pub. No.: US 2010/0089726 A1
(43) Pub. Date: Apr. 15, 2010

(54) Fixturized conveyor assembly with non-synchronous product transportation capability

(75) Inventors: Thomas Edward Van Wormer, Gaines, MI (US); Gregory James Crean, Harrisville, MI (US); George Michael Macsuga, Greenbush, MI (US)

Correspondence Address: THOMAS VAN WORMER, 12347 HOISINGTON RD., GAINES, MI, 48436, US

(73) Assignee: GREAT LAKES TECHNOLOGIES & MFG, LLC

(21) Appl. No.: 12/228,124

(22) Filed: Oct. 10, 2008

(51) Int. Cl. B65G 17/00

(52) U.S. Cl. 198/867.14

(57) ABSTRACT

A Non-Synchronous conveyor which utilizes fixtures or pallets to transport a product from point to point. The fixtures follow a roller chain with special attachments. The roller chain is driven by a sprocket. The fixtures or pallets are supported by roller assemblies which roll along the conveyor frames. Pneumatic cylinders are triggered by electric solenoid operated valves to block the path of the fixture, thus stopping the fixture in desired locations or work station.

### BACKGROUND OF THE INVENTION

This invention is relative to a type of conveyor commonly utilizing fixtures or pallets supported by a chain or chains to transport products or parts to and from a series of work stations, where processes are performed on the products. Some of these conveyors employ fixtures or pallets which are physically attached to the chain, and are synchronous only or indexing while others allow the fixtures to disengage from the chain and are asynchronous and the chain is always continuously traveling. Other conveyors use a frictional brake concept to engage the chain allowing the chain to overcome the friction brake mechanism when the fixture is stopped in a work station or for accumulation of part fixtures-still others employ clutch sprockets to engage the chain allowing the chain to overcome the clutch sprocket mechanism when the fixture is stopped in a work station or for accumulation of part fixtures. One such conveyor assembly is described in U.S. Pat. No. 7,258,223 B2 and another conveyor assembly in U.S. Pat. No. 6,568,525 B2, it is desirable to simplify these conveyors by eliminating the friction brake and clutch sprocket devices required by the prior art designs as described in the afore mentioned U.S. patents.

### SUMMARY OF THE INVENTION

The advantages, objects, and features of the invention will be apparent upon reading the following specification and claims and are achieved by a conveyor which transports pallets or fixtures from point to point and around curves without the need for costly to fabricate, friction brake or clutch sprocket devices.

This fixture conveyor utilizes a single strand roller chain with attached brackets which support camfollower style rollers. The chain is supported by the cam rollers and guided along a pair of rails which are mounted along the conveyor frame.

Pallets are supported by flat wheels which roll along the conveyor frame. The pallets rest on alloy steel blocks which are attached to the top of the conveyor chains. The weight of the pallet and fixtured part or product being conveyed produces the friction required to tow the pallet along the conveyor. This is accomplished without using any friction brake assemblies or pivoted swing bars with clutch sprockets.

To allow accumulation of pallets or stop individual pallets in work stations, a pneumatic cylinder is extended to block the path of the moving pallet. When this is accomplished the pallet is stopped along the conveyor and the chain will continue to travel and slides past the stopped pallets. The sliding contact between the chain and the pallets is accomplished utilizing a self lubricating long wearing alloy steel block (or a nylon plastic for lighter loads) attached to the chain which contacts a hardened steel bar that is moving on the pallet.

### DESCRIPTION OF THE DRAWINGS

FIG. 1 is an end elevation view of a conveyor according to the present invention.

FIG. 1a is a close up end view of the chain with attached bars and camfollower style rollers attached. This view also shows the flat wheels and how they support the pallet.

FIG. 2 is a side elevation view of a conveyor shown in FIG. 1

FIG. 3 is a plan view of a conveyor shown in FIG. 1 and FIG. 2

FIG. 4 is a close up side elevation view of the chain with the attached blocks supporting the alloy bars on the pallet. It also shows the attached camfollower style rollers attached to every other chain link.

### DETAILED DESCRIPTION OF PREFERRED EMBODIMENTS

In the following detailed description certain specific terminology will be employed for the sake of clarity and a particular embodiment described in accordance with the requirements of 35 USC112 but it is understood that the same is not intended to be limiting and should not be so construed inasmuch as the invention is capable of taking on many forms and variations within the scope of the appended claims.

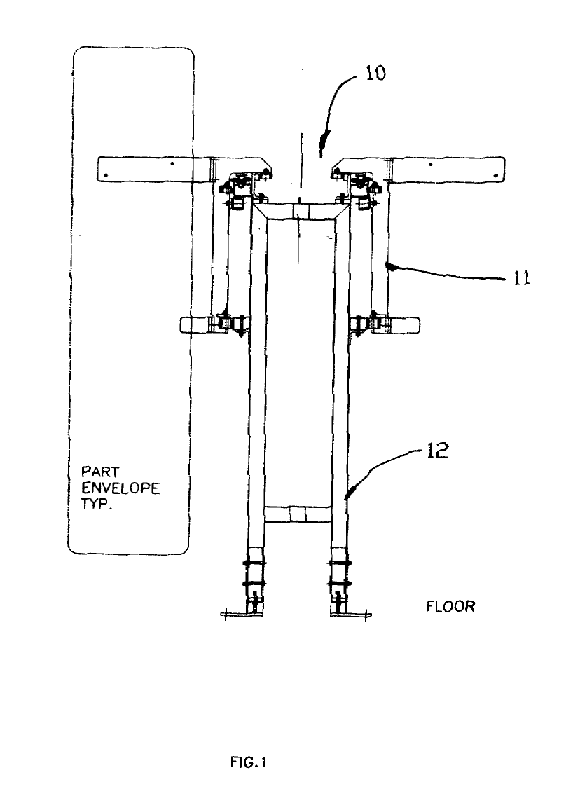

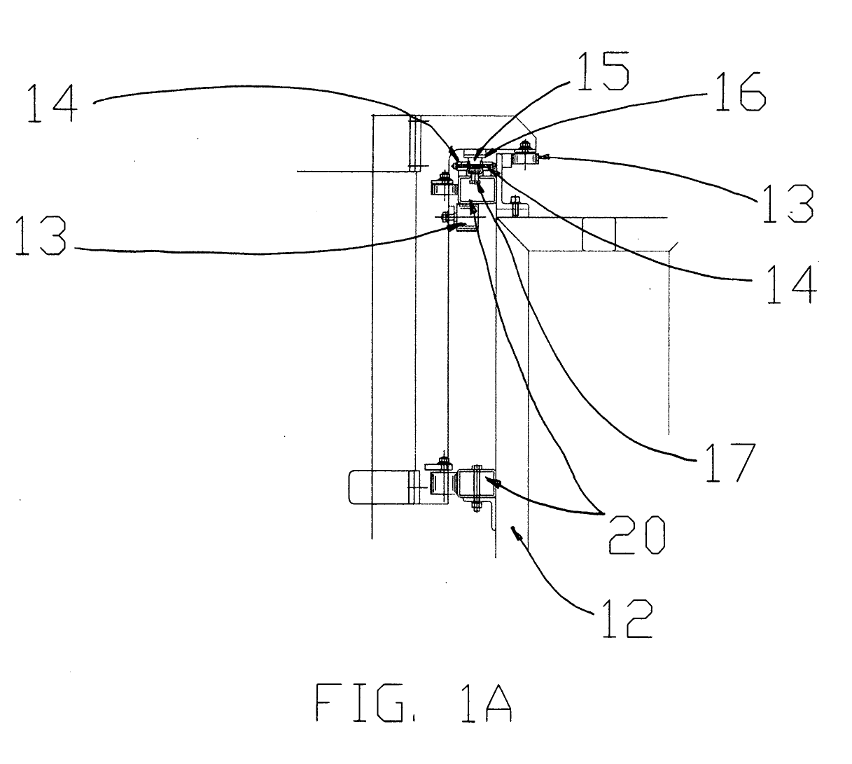

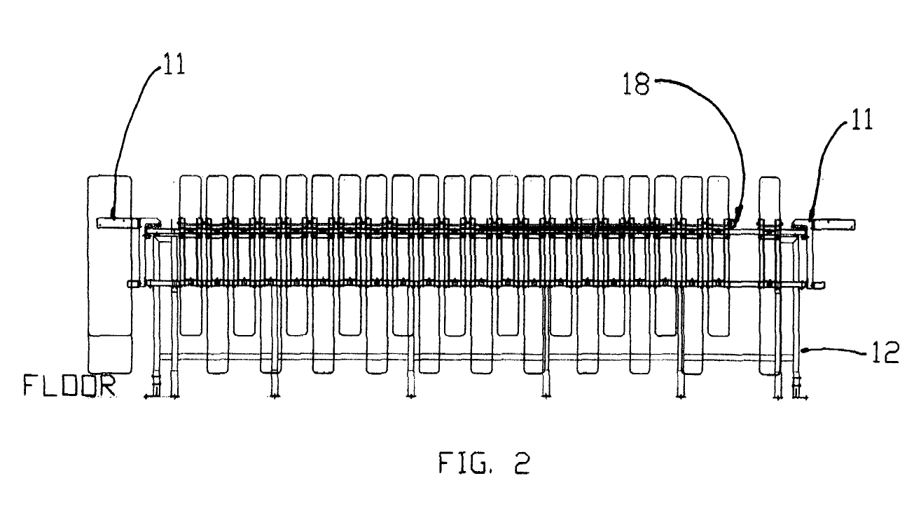

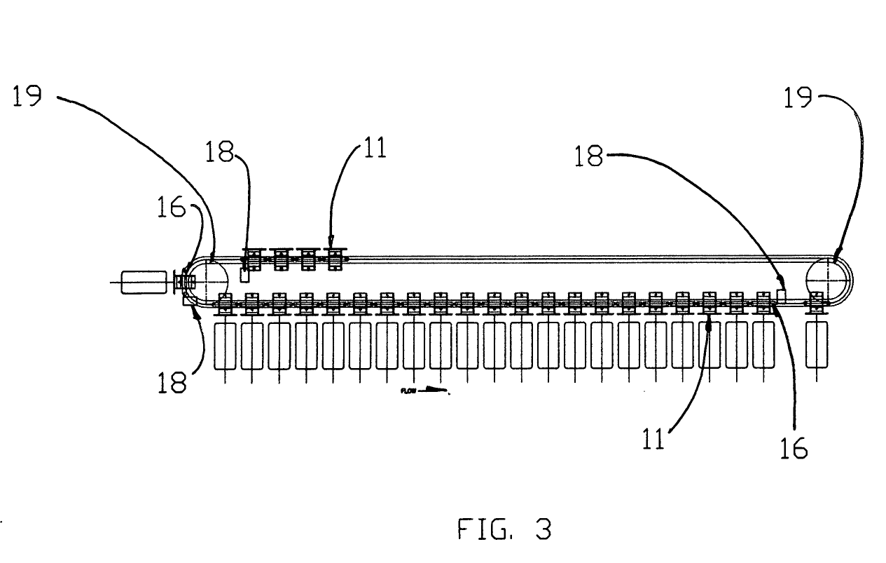

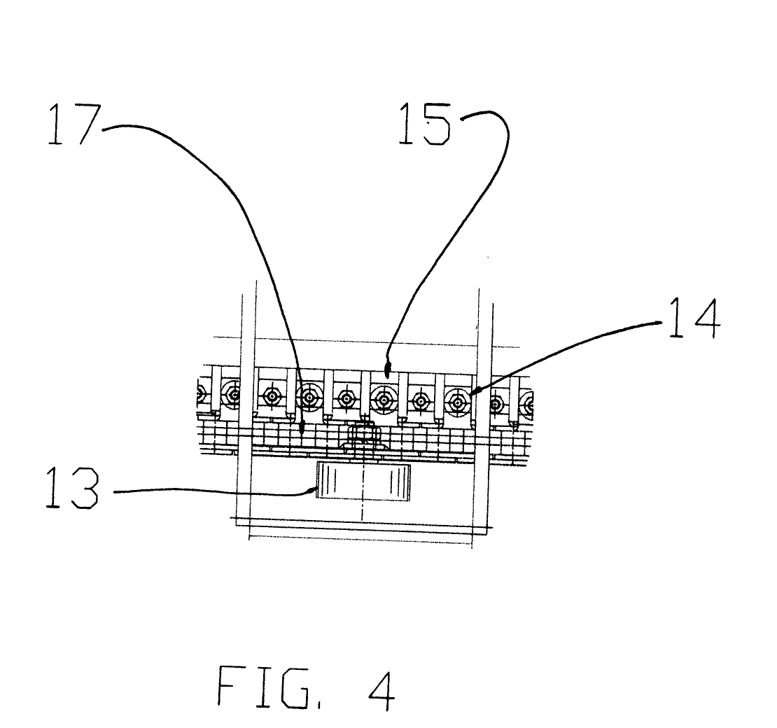

Referring to the drawings, FIGS. 1-4 illustrate a conveyor 10, according to the present invention which includes support legs, 12 part fixturized pallets 11, single strand roller chain with attached brackets 17, camfollower style rollers 14, alloy steel or nylon blocks 15, and hardened steel bars 16.

Pallets are supported by rollers 13, which roll along the steel frame 20. The conveyor chain is looped around the sprockets 19. One sprocket is fixed to a driven shaft and the other is fixed to a free turning shaft. The driven shaft is powered by a typical conveyor drive motor assembly.

The fixturized pallets are stopped at predetermined locations by pneumatic cylinders 18, when said cylinders are extended by activation of a typical pneumatic control valve. Pallets are released and continue moving once again when the pneumatic cylinder 18, is retracted by activation through the typical pneumatic control valve.

The invention claimed is:

1. A conveyor comprising:
A roller chain on edge, supported from framework which is floor supported with a driven sprocket and a non driven sprocket;
Part holding fixtures, otherwise called pallets are conveyed by the roller chain without the conventional methods of using friction brake or spring powered sprocket devices to engage the chain.

2. The conveyor assembly of claim 1, whereas nylon blocks and or alloy steel blocks are utilized in conjunction with hardened steel bars attached to multiple part holding fixtures or pallets to create the required friction for the said pallets to move but still accumulate when the path of said pallets is blocked by a pneumatic cylinder.
